(19) United States
(12) Patent Application Publication
(10) Pub. No.: US 2003/0112847 A1
(43) Pub. Date: Jun. 19, 2003

(54) Thermometric nursing bottle

(76) Inventor: Ming-Tun Hsiao, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/015,770

(22) Filed: Dec. 17, 2001

(51) Int. Cl. G01K 1/14; G01K 13/00; G01K 1/16

(52) U.S. Cl. 374/150; 374/120

(57) ABSTRACT

A thermometric nursing bottle in which a thermal cell with good thermal conductivity is fixed on bottom section of the nursing bottle to directly contact with a liquid in the nursing bottle. The thermal cell conducts the temperature of the liquid to a thermosensor and an LCD directly truly displays the temperature of the liquid in the nursing bottle.

### BACKGROUND OF THE INVENTION

The present invention is related to a thermometric nursing bottle in which a thermal cell is fixed on the nursing bottle to directly measure the temperature of a liquid in the nursing bottle. A display unit immediately truly displays the temperature of the liquid in the nursing bottle.

FIG. 6 shows a conventional nursing bottle with a thermometer. One end of the nursing bottle 40 is formed with a receptacle 41 in which a thermometer 42 is disposed for measuring the temperature of the liquid in the nursing bottle 40.

The receptacle 41 is slightly larger than the thermometer 42 and a gap exists between the wall of the receptacle 41 and the thermometer 42. Moreover, the thermometer 42 is isolated from the liquid by the wall of the nursing bottle 40. Therefore, the temperature of the liquid in the nursing bottle 40 is conducted to the thermometer 42 through the wall of the nursing bottle 40 and the gap in the receptacle 41. As a result, the thermometer 42 can hardly quickly measure and truly show the temperature of the liquid in the nursing bottle 40. Furthermore, when a user blends cold water and hot water with each other, the temperature of the water in the nursing bottle 40 continuously changes. In case the thermometer 42 fails to instantaneously reflect the temperature of the water in the nursing bottle 40, the temperature may be too high or too low and the baby may feel uncomfortable or even get hurt.

Moreover, the receptacle 41 of the nursing bottle 40 inward protrudes from the wall of the nursing bottle 40 and forms a turning corner therein. When a user washes the nursing bottle 40 with a nursing bottle brush (not shown), it is uneasy for the user to fully clean the inner side of the nursing bottle 40. As a result, bacteria may culture in the nursing bottle 40.

In order to solve the above problem, a thermometric belt for a nursing bottle has been developed as shown in FIG. 7. One end of the thermometric belt 50 is formed with a through hole 51 in which the nursing bottle 60 is fitted. Two magic attachable straps 52 are disposed at two ends of the thermometric belt 50. The attachable straps 52 can be attached to each other to locate the thermometric belt 50 on the nursing bottle 60. A widened band 53 is formed between the attachable straps 52. Multiple thermometric units (not shown) are disposed on the widened band 53. Each thermometric unit is equipped with a display 54 for displaying the temperature of the water in the nursing bottle 60 measured by the thermometric unit.

The thermometric belt 50 encircles the body of the nursing bottle 60 so that the interior space of the nursing bottle 60 is smooth without dead corner. However, the thermometric belt 50 is fitted around the outer side of the nursing bottle 60 so that the temperature of the liquid in the nursing bottle 60 is still conducted to the thermometric units through the wall of the nursing bottle 60. As a result, the thermometric units still can hardly quickly measure the temperature of the liquid in the nursing bottle 60. Moreover, the displays 54 can only show the temperature of the liquid in a certain division of the nursing bottle 60. Therefore, it is hard for a user to immediately truly know the temperature of the liquid in the nursing bottle 60. As a result, a baby may still feel uncomfortable or even get burned by too hot water.

### SUMMARY OF THE INVENTION

It is therefore a primary object of the present invention to provide a thermometric nursing bottle in which a thermal cell with good thermal conductivity is fixed on lower section of the nursing bottle to directly contact with a liquid in the nursing bottle. The thermal cell directly conducts the temperature of the liquid to a thermosensor and an LCD immediately truly displays the temperature of the liquid in the nursing bottle. Accordingly, a user can quickly know the temperature of the liquid without error to avoid too high temperature. Therefore, a baby is protected from being burned and the safety can be ensured.

It is a further object of the present invention to provide the above thermometric nursing bottle in which after the thermometric device is assembled with the nursing bottle, the internal space thereof is smooth without any turning corner. Therefore, a user can fully clean the nursing bottle with a nursing bottle brush.

The present invention can be best understood through the following description and accompanying drawings wherein:

### BRIEF DESCRIPTION OF THE DRAWINGS

FIG. 1 is a perspective exploded view of the present invention;

FIG. 2 is a perspective assembled view of the present invention;

FIG. 3 is a sectional assembled view of a part of the present invention;

FIG. 4 shows the use of the present invention;

FIG. 5 shows that the thermometric device of the present invention is detached from the nursing bottle for a user to easily wash the nursing bottle;

FIG. 6 is a perspective view of a conventional nursing bottle; and

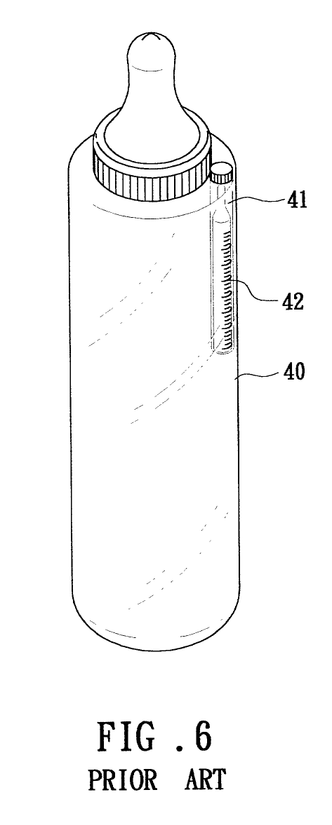

FIG. 7 is a perspective view of another type of conventional nursing bottle.

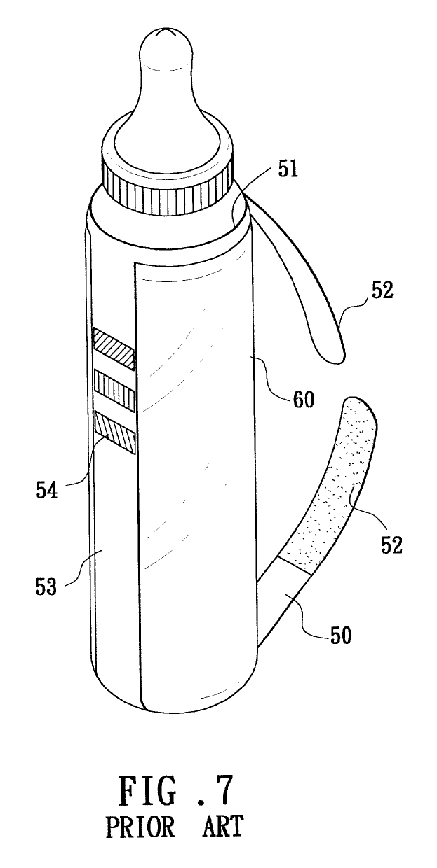

### DETAILED DESCRIPTION OF THE PREFERRED EMBODIMENTS

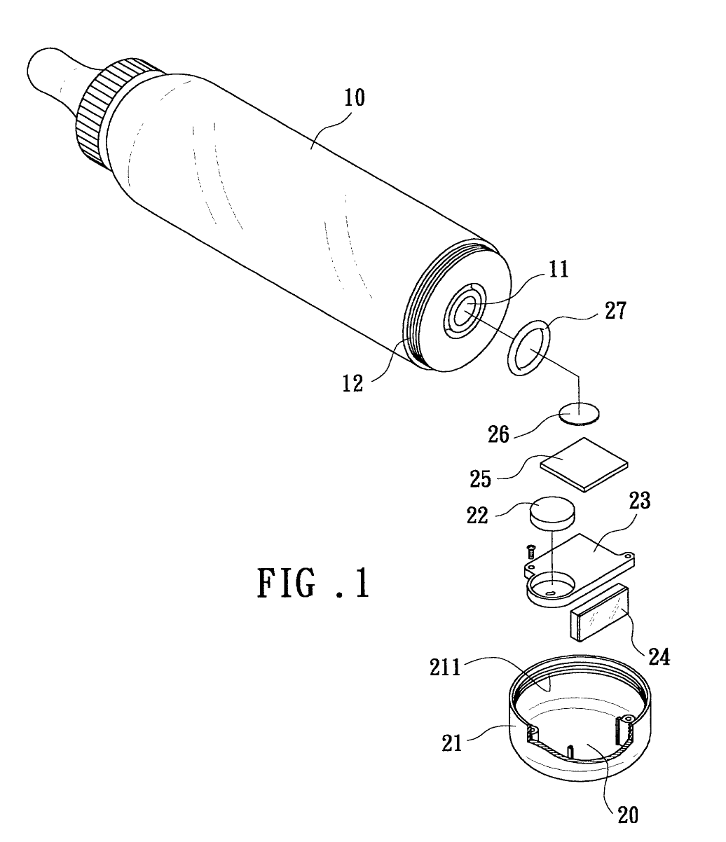

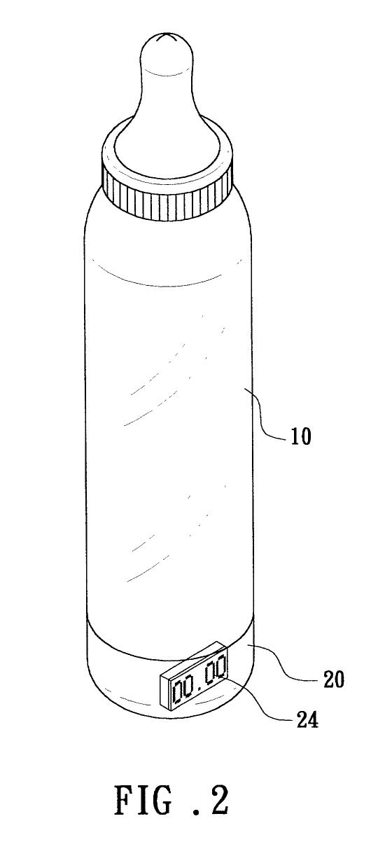

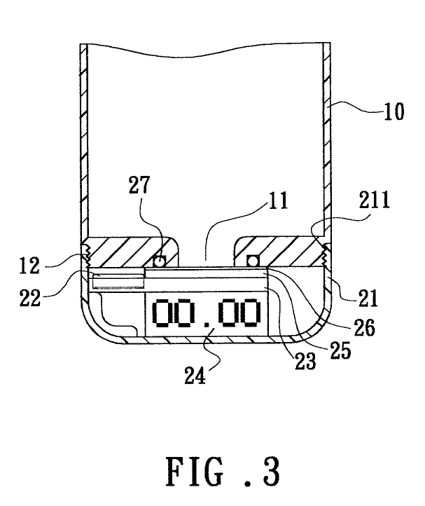

Please refer to FIGS. 1 to 3. The thermometric nursing bottle 10 of the present invention is equipped with a thermometric device mounted on the bottom of the nursing bottle.

The bottom of the nursing bottle 10 is formed with a through hole 11 and an outer thread section 12.

The thermometric device includes a base seat 20 made of transparent material. The base seat 20 has a skirt 21 upward extending from the circumference of the base seat 20. The inner circumference of the skirt 21 is formed with an inner thread section 211 in cooperation with the outer thread section 12 of the nursing bottle 10. A circuit board 23 having a controlling circuit is mounted in the base seat 20. The circuit board 23 is provided with a cell 22 and connected with a display unit. In this embodiment, the display unit is an LCD 24. The circuit board 23 is further connected with a thermosensor 25. A thermal cell 26 with good thermal conductivity is tightly attached to the thermosensor 25. In this embodiment, the thermal cell 26 is a food class stainless steel thermal cell 26. The inner thread section 211 of the base seat 20 is screwed with the outer thread section 12 of the nursing bottle 10 so as to make the thermal cell 26 abut against the bottom face of the through hole 11 of the nursing bottle 10. A watertight washer 27 is disposed on the thermal cell 26 around the through hole 11 to prevent the liquid in the nursing bottle 10 from flowing into the base seat 20.

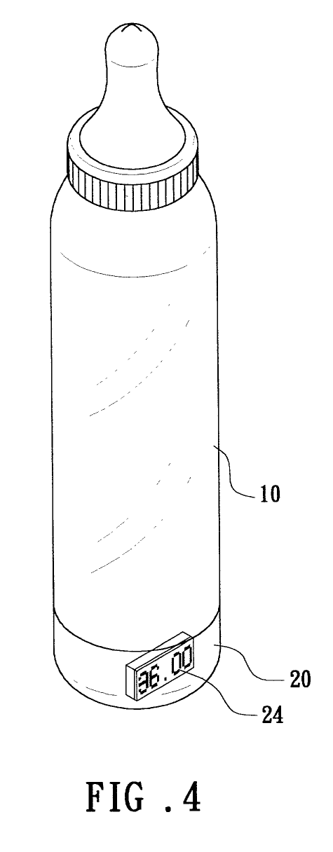

Please refer to FIG. 4. When a user desires to use the present invention to blend cold water with hot water, the liquid in the nursing bottle 10 through the through hole 11 thereof will directly contact with the thermal cell 26. When blending the cold and hot water, the temperature of the liquid in the nursing bottle 10 continuously changes. The temperature of the liquid in the nursing bottle 10 via the thermal cell 26 is conducted to the thermosensor 25. The controlling circuit of the circuit board 23 converts the temperature sensed by the thermosensor 25 into digitals displayed on the LCD 24. Accordingly, the temperature of the liquid in the nursing bottle 10 is immediately reflected to avoid too high temperature. Therefore, a baby is protected from being burned by the hot liquid and safety can be ensured.

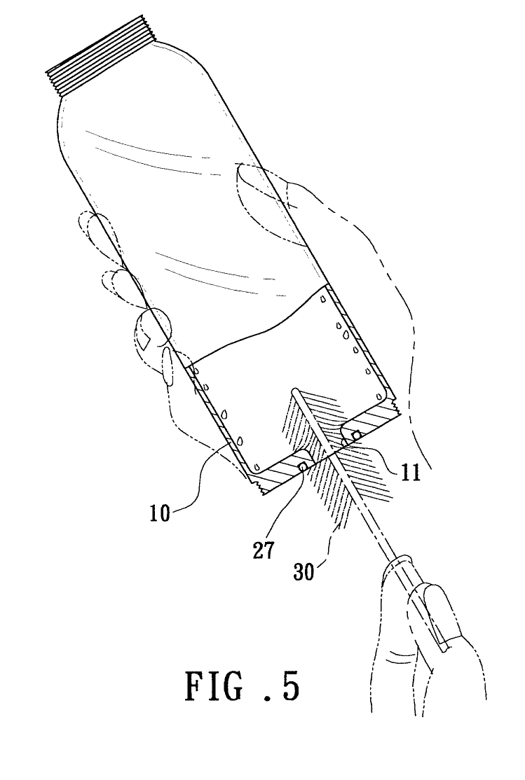

Please refer to FIG. 5. When washing the nursing bottle 10, the teat 13 and the base seat 20 of the nursing bottle 10 are taken off. It is easy to take off the base seat 20 by means of unscrewing the base seat 20 therefrom. The user can directly use a nursing bottle brush 30 to brush the interior of the nursing bottle 10. After the thermometric device is assembled with the nursing bottle 10, the internal space thereof is smooth without any turning corner. Therefore, the user can fully clean the nursing bottle 10 with the brush 30.

Furthermore, the thermometric device of the present invention is separably assembled with the nursing bottle 10 so that when washing the nursing bottle 10, the thermometric device is prevented from malfunctioning.

A leaf spring (not shown) can be further disposed on the circuit board 23 to press the thermosensor 25 and make the same tightly contact with the thermal cell 26. Accordingly, a true thermometric effect can be achieved.

Alternatively, the base seat 20 and the nursing bottle 10 can be assembled by means of other conventional measures such as tenon/mortise measure. Such measure also enables a user to easily assemble the base seat with the nursing bottle or disassemble the base seat from the nursing bottle. Alternatively, the base seat 20 can be arranged in any of other positions of the nursing bottle. For example, the base seat 20 can be fixed on a lateral side of the nursing bottle.

Alternatively, the thermal cell 26 can be embedded in the lateral wall of the nursing bottle 10 when manufactured. One face of the thermal cell 26 is flush with the inner circumference of the wall of the nursing bottle. Accordingly, the temperature of the liquid in the nursing bottle 10 can be also directly measured and no dead corner in cleaning is formed.

According to the above arrangement, the present invention has the following advantages:

1. The temperature of the liquid in the nursing bottle can be quickly known. The thermal cell with good thermal conductivity is fixed on lower section of the nursing bottle. The surface of the thermal cell directly contacts with the liquid in the nursing bottle and conduct the temperature of the liquid to the thermosensor 25. The LCD immediately truly displays the temperature of the liquid in the nursing bottle. Accordingly, a user can quickly know the temperature of the liquid without error to avoid too high temperature. Therefore, a baby is protected from being burned and the safety can be ensured.

2. The nursing bottle can be conveniently washed. After the thermometric device is assembled with the nursing bottle, the internal space thereof is smooth without any turning corner. Therefore, a user can fully clean the nursing bottle with a nursing bottle brush.

The above embodiments are only used to illustrate the present invention, not intended to limit the scope thereof. Many modifications of the above embodiments can be made without departing from the spirit of the present invention.

What is claimed is:

1. A thermometric nursing bottle comprising a thermometric device mounted on lower section of the nursing bottle, the thermometric device including a base seat, a circuit board disposed in the base seat, a thermosensor connected with the circuit board and a thermal cell disposed in the base seat, one face of the thermal cell directly contacting with a liquid in the nursing bottle, while the other face of the thermal cell tightly contacting with the thermosensor, whereby the thermal cell conducts the temperature of the liquid to the thermosensor and a display unit directly displays the temperature.

2. The thermometric nursing bottle as claimed in claim 1, wherein a bottom of the nursing bottle is formed with an outer thread section, the base seat having a skirt upward extending from the circumference of the base seat, inner circumference of the skirt being formed with an inner thread section in cooperation with the outer thread section of the nursing bottle.

3. The thermometric nursing bottle as claimed in claim 1, wherein the bottom of the nursing bottle is formed with a through hole, the thermal cell being tightly attached to outer side of the through hole, a watertight washer being disposed on the thermal cell around the through hole.

4. The thermometric nursing bottle as claimed in claim 1, wherein a leaf spring is disposed on the circuit board to press the thermosensor and make the same tightly contact with the thermal cell.
